(19) United States
(12) Patent Application Publication
(10) Pub. No.: US 2003/0079223 A1
(43) Pub. Date: Apr. 24, 2003

(54) Methods for enhancing broadcast media advertising

(76) Inventor: Richard L. Galloway, Houston, TX (US)

Correspondence Address: Sue Z. Shaper, Suite 930, 2925 Briar Park Drive, Houston, TX, 77042, US

(21) Appl. No.: 09/947,730

(22) Filed: Sep. 6, 2001

Related U.S. Application Data
(60) Provisional application No. 60/253,572, filed on Nov. 28, 2000.

(51) Int. Cl. H04N 7/16; H04N 7/173

(52) U.S. Cl. 725/32; 725/1; 725/132; 725/39

(57) ABSTRACT

Methods and apparatus for enhancing broadcast media advertising including methods and apparatus for communicating the timing of ad broadcasts to advertising clients prior to broadcast, including using the output of a traffic and billing program; for catching errors in a scheduling program and for assessing the effectiveness of execution for scheduling purposes.

This invention relates to and claims priority based on co-pending U.S. provisional application Serial No. 60/253,572 filed Nov. 28, 2000.

### FIELD OF THE INVENTION

The invention relates to methods and apparatus for enhancing the value of media advertising and for review of the advertising, and more particularly to methods and apparatus for advising advertising clients about the scheduling of their ads prior to broadcast; for facilitating the review of ad schedules by account representatives; for checking for errors or omissions in a traffic and billing system or the like, such as inadvertent media deletion; and for assessing the accuracy of media insertion technique and/or for assessing advertising exposure as a result of a broadcast media insertion of ads based on a Schedule Log/Inserter Log or the like.

### BACKGROUND OF THE INVENTION

The sale of advertising by communication companies is multi-faceted. Guaranteed specified locations and times for an ad vis-à-vis communication media are sold for the highest price. Advertising contracts for locations and times within general ranges on communication media sell for lesser prices.

A “traffic and billing system” creates Schedule Logs/Inserter Logs that schedule a communication company's advertising clients' ads for a coming period, as per all of the client contracts. The Schedule Log satisfies contracts guaranteed for specified inserter locations and times. The times remaining at inserter locations are filled into the Schedule Logs with ads of advertisers who opted for less certainty with a lower price. Some advertisers, thus, may get their ads run at a prime time and in a prime inserter location even though they paid a lesser price. However, such exposure is not guaranteed. The uncertainty involved as to the actual scheduling of ads, given the contract a client elected, makes a preview of ad scheduling both interesting and valuable to advertising clients. The advertising clients' account executive may also find such a preview helpful.

Furthermore, traffic and billing systems have been known to inadvertently omit inserters, e.g. a channel or network in a geographic zone. It is valuable to catch such omissions. Inserters, also, do not execute Schedule Logs perfectly. Thus, a RunRate efficiency report is helpful, reporting upon the execution efficiency in regard to a Schedule Log/Inserter Log. Such report can be general or tailored to advertising clients. A RunRate report could be valuable to a communications company, to an account executive and/or to an advertising client.

Prior to the present invention, when a client advertiser on broadcast media wanted advance notice of the times/channels/stations/sites scheduled for airing that client's ads, the request entailed significant human intervention. (“Broadcast” is used herein to indicate any commercial communication system, including transmission by cable, line, satellite, antenna, or the like, free or for pay, including transmissions over the Internet.) Typically, a person associated with a communication company would first need to review a record of which clients wanted such advance notice of scheduled times and locations for ad airing. The person would then typically manually request a “traffic and billing system” (or some equivalent) to download a scheduled time/site report for or including that client. The person would then prepare to the extent necessary and fax the report to the client. See FIG. 1A illustrating a typical prior art system. In FIG. 1A, HQ refers to “human question”; HR refers to “human request”; HF or HE refers to “human faxing” or “human emailing”.

The instant invention in one embodiment automates and improves upon such prior art systems. The instant invention electronically queries whether there are advertising clients that request advance notification of scheduled times (and sites or inserter locations, to the extent relevant) for ads. The instant system is adapted to automatically electronically communicate with an electronically stored record of ads scheduled to be “aired”, typically created by one of a variety of “traffic and billing systems” or their equivalent. Given access to the electronic record, the instant system produces a client advisory report of scheduled times (and sites and other pertinent information if relevant and desired) for scheduled ads in advance of broadcast (e.g. prior to at least some significant broadcast) and preferably automatically faxes the report to the client. Alternately, the report could be sent automatically by e-mail or other means. For instance, the report could be posted on the Internet for client access, preferably by a password.

In addition to performing the above function, the system of the instant invention can send a master advisory report of scheduled broadcast times and ads (and sites, etc. if relevant) to an account representative of the client for his/her review and assessment. Furthermore, the instant system can be used to check for inadvertent errors by a traffic and billing system or the like, such as the omission of media like a channel or a station or a site, in the Schedule Logs/Inserter Logs produced by the system. The instant system, with access to verified files or the like, can produce Run Rate summaries, by company, by inserter or by advertising client. In the latter instance the details of any run failure could also be reported.

### SUMMARY OF THE INVENTION

The invention includes improved methods and apparatus for communicating in advance to those concerned, including in particular advertising clients, the scheduled timing for ad broadcasts. Ad broadcasts refer to ads offered on or over broadcast media. The term broadcast media covers TV, radio, and the like communications, including the Internet. Broadcast covers communications transmitted by literal broadcast and/or by cable, by line, by satellite, by antenna, by Internet, etc. Use of the phrases electronically accessing, electronically generating and/or electronically transmitting indicates an automatic management of a process, as by a computer program. Media is used herein to refer to a particular channel, or a station in a geographic zone, or an Internet site or the like. “Title” is used herein to refer to some identifier of a particular ad or copy or spot or banner. An inserter, when the term is used, paradigmatically refers to hardware that inserts advertising into a particular media broadcast system.

The method and apparatus of the instant invention includes electronically accessing, including in advance, an electronically stored record containing (explicitly or implicitly) media, times and titles for ads to be broadcast in a given upcoming period; electronically generating a report including, directly or indirectly, at least the time for the broadcast of at least one client ad for a future period; and electronically transmitting the report to a client in advance of or prior to broadcast. (A client should be understood to include the client's agents or designees.) The method and apparatus can include transmitting report information to a client account representative for review and approval. The method and apparatus can also include providing means for checking for scheduling errors, such as the inadvertent omission of inserters from Schedule Logs by a traffic and billing system, a historic problem, and for reporting RunRate efficiency.

The method of transmitting includes in particular transmitting by fax and/or by e-mail, the preferred means of transmitting. Transmitting can also include making available through networks and the Internet.

Preferably electronically stored records are created by traffic and billing systems or the like and the instant system is capable of recognizing and reading records created by a variety of such systems or their equivalents.

### BRIEF DESCRIPTION OF THE DRAWINGS

A better understanding of the present invention can be obtained when the following detailed description of the preferred embodiment is considered in conjunction with the following drawings, in which:

FIG. 1A indicates a typical prior art manual system that requires significant human intervention, while FIG. 1B indicates a system in accordance with the present invention.

FIG. 2 indicates, on a supervisory level, work flow of a preferred embodiment of the instant invention, the preferred embodiment referred to as the AirCheck System.

FIG. 3 illustrates a Fax Times Module flow diagram of a preferred embodiment of the instant invention, the AirCheck System.

FIG. 4 illustrates a Check Data Module flow diagram option of a preferred embodiment of the instant invention.

FIG. 5 illustrates a Print Schedules Module flow diagram option of a preferred embodiment of the instant invention.

FIG. 6 illustrates a general flow diagram of a preferred embodiment program of the instant invention.

FIG. 7 illustrates the interaction of a preferred embodiment of the present invention with a traffic and billing system, a schedule log and an insertion system of a broadcaster.

FIG. 8 illustrates the date range window with comment attachment.

FIG. 9 is an example of a client report with a banner.

FIG. 10 illustrates a sample of missing files shown to user.

FIG. 11A illustrates a RunRate Module Selection window.

FIG. 11B illustrates a RunRate Module Flow diagram.

Table 1 illustrates a sample portion of a Text File of a Schedule Log—a Single Channel Log.

Table 2 illustrates a sample portion of a Text File of a Schedule Log—All events for a Single Day Log.

Table 3 illustrates a sample client report.

Table 4 illustrates an inserter data file.

Table 5 illustrates raw parsed data.

Tables 6 and 7 illustrate RunRate reports.

Tables 8A and 8B show file title and single file configurations.

### DETAILED DESCRIPTION OF PREFERRED EMBODIMENTS

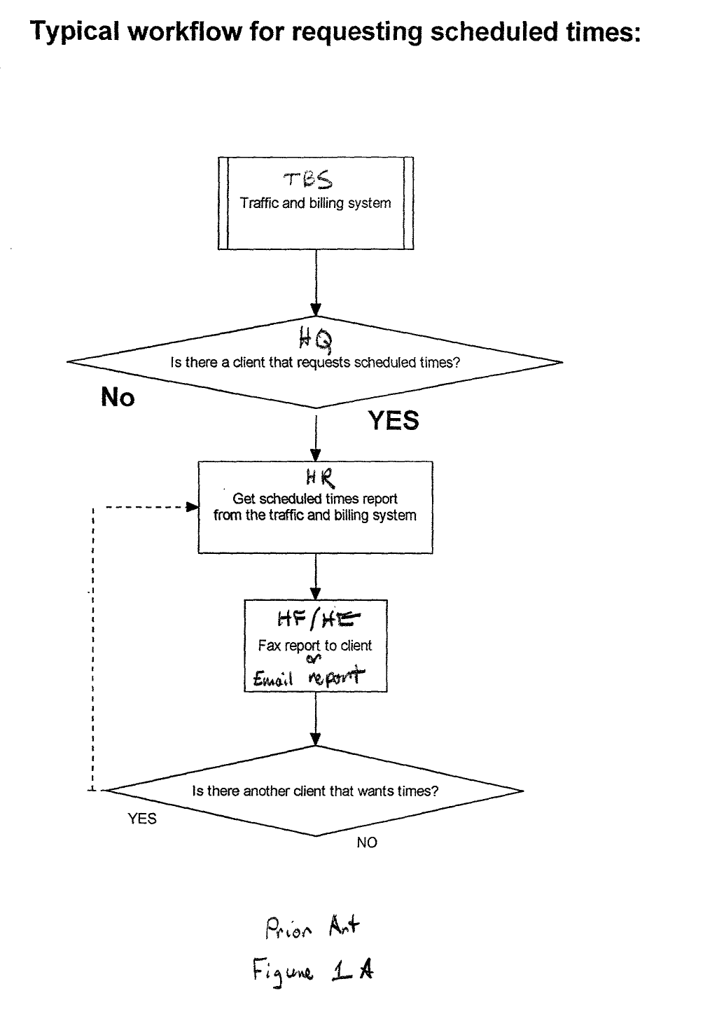

One preferred embodiment of the instant invention is referred to herein as the AirCheck program. This program ascertains an advertising client's scheduled spots from a review of Schedule Logs or Event Logs and faxes (or emails) their times (and sites and other pertinent data, to the extent relevant and/or requested) to advertising clients of a communications company. See FIG. 1B. The preferred program provides for starting and stopping on any scheduled day or days (or relevant periods). It is possible with the preferred system to additionally alert clients as to when their spots are no longer scheduled and their advertising has ceased, in whole or in part. As enhancements, modules are in place to discover and display scheduling errors, such as inadvertently missing media from a set of Schedule Logs and/or to print out ad schedules for an upcoming period for review by a client's account representatives. Optional modules may prepare RunRate efficiency reports, by company, by inserter and/or by advertising client.

The instant program has the advantage of offering advertising clients increased value in their association with a communications company. The system assists advertising clients in being able to witness and experience, or have someone else witness and experience, their advertising on a broadcast system as it airs. The preferred system further allows an operator to double-check Schedule Logs/Inserter Logs against inserter lists for inadvertent errors, such as dropping an inserter, and allows for an account representative to monitor a client's allotted time and inserter locations.

A communications company, such as a television broadcast system or cable system, typically uses one of several commercially available “traffic and billing programs” to schedule ads or spots for a variety of media at a variety of times and geographical locations over a designated period for a set of advertising clients, as per the clients' contacts. A traffic and billing system, at least shortly before a designated period begins, produces a record (such as a Schedule Log or an Event Log and/or an Inserter Log) of all scheduled spots for ads on the set of media the communications company manages within a next designated period.

This record is stored electronically. Various inserter hardware systems corresponding to various media and zones have access to the Schedule or Event Logs and/or Inserter Logs in order to find and locate the scheduled ad spots and insert the proper ad spots at the appropriate time in the appropriate channels or stations in the proper zones. Typically the formats for the records created by traffic and billing systems are relatively standardized. Embodiments of the present invention are designed to electronically access such electronically stored records created by such traffic and billing systems or the like, typically but not necessarily stored in a standardized format. In accordance with preferred embodiments, the program of the instant invention accesses a record, copies the record and culls from the record unneeded data. In accordance with client requests, a report can be generated for each requesting advertising client exhibiting, for the next relevant period, the ads of a client to be broadcast, the media of the broadcast if relevant and the timing of the broadcast. Other information as pertinent or requested may be included. A sample page of such a report, as may be faxed or emailed to a client, is illustrated in Table 3. The report of Table 3 indicates the ad or spot both by code and by title.

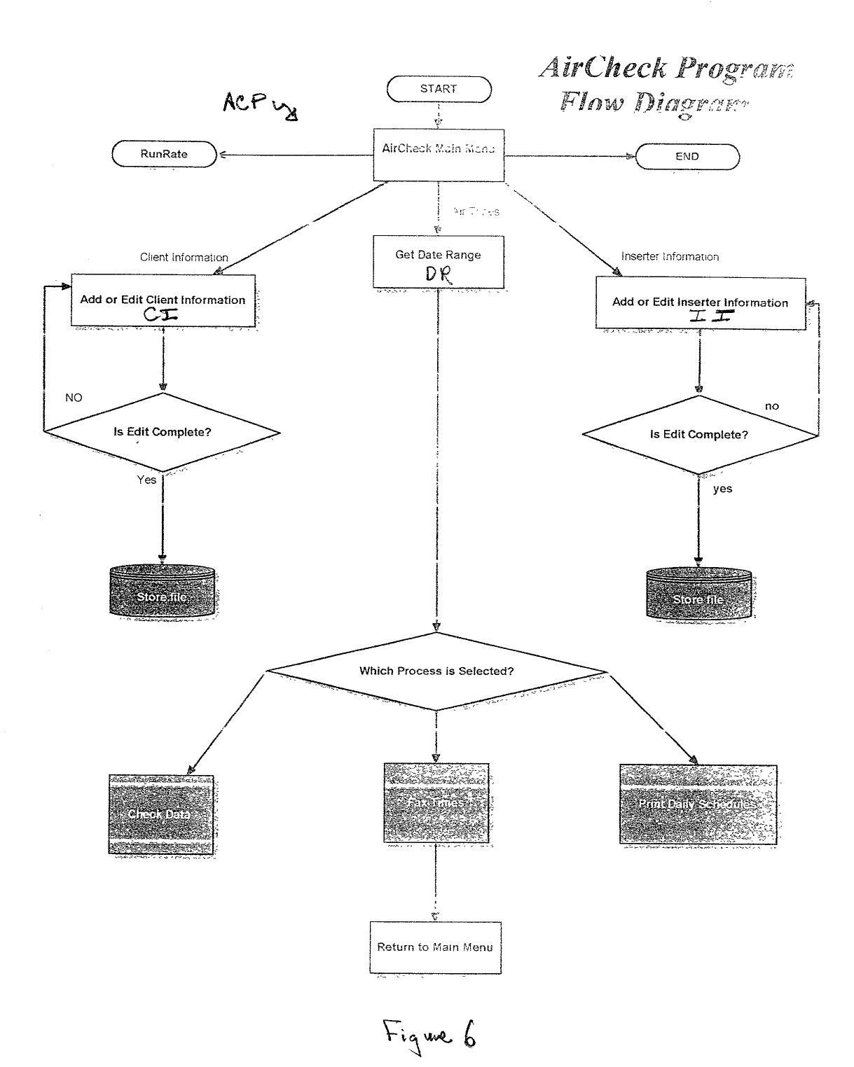

Alternately, if a traffic and billing system is capable by itself of generating a report by advertiser of scheduled spots for an upcoming period, one embodiment of the instant invention may connect an AirCheck Program residing on a workstation or the like to a traffic and billing system residing on a network server or the like. The AirCheck program would be configured to request or to emulate a human keystroke request for such a report, as illustrated in FIG. 7, in order to have a traffic and billing system report generated and forwarded to it.

As more particularly indicated in FIG. 7 an AirCheck Program could reside in a workstation or terminal W. The workstation or terminal W could be connected to a traffic and billing system TBS residing on a network server or the like. The traffic and billing system TBS is illustrated as creating a daily Schedule Log using as input entered client requested spots and client contract information. The Schedule Log SL could reside on a hard drive HD or network or the like. In such embodiments an AirCheck Program ACP could directly have access to Schedule Log SL on the hard drive HD or network or the like. The AirCheck Program ACP is shown producing a client report R. A commercial inserter system CIS, which is a hardware system, should also have access to the Schedule Log SL (or Inserter Log) on the hard drive HD or network or the like.

It should be understood that a traffic and billing system TBS might create several hundred Schedule Logs SL's to correspond to several hundred individual inserters. A Schedule Log and an Event Log generally refer to the same log. An Inserter Log generally contains the same information as a Schedule Log or Event Log but in different text or format.

Table 2 illustrates a portion of a text file of a Schedule Log (sometimes referred to as an Event Log) of a traffic and billing system, including all events for a single day for a communications company. Table 1 illustrates a portion of a text file of a Schedule Log illustrating a single channel or single inserter. Table 2 is a multiple inserter log which illustrates the inserter, the time of day, the advertiser and the title of the ad. The ad code number is also illustrated. The single channel log of Table 1 also illustrates the advertiser together with the code number and the title of the ad.

In a preferred embodiment, client data is submitted to an AirCheck Program, as is inserter data, the client data including which clients request a scheduled times report. The client data might include more detailed information or specialized reporting requests. Inserter data might include identification numbers or letters identifying the advertised channel and area of that advertised channel to both the traffic and billing system and the commercial insertion system. The inserter data might also include descriptions of advertised channels and areas as well as the location of the directory occupying the daily event or schedule logs.

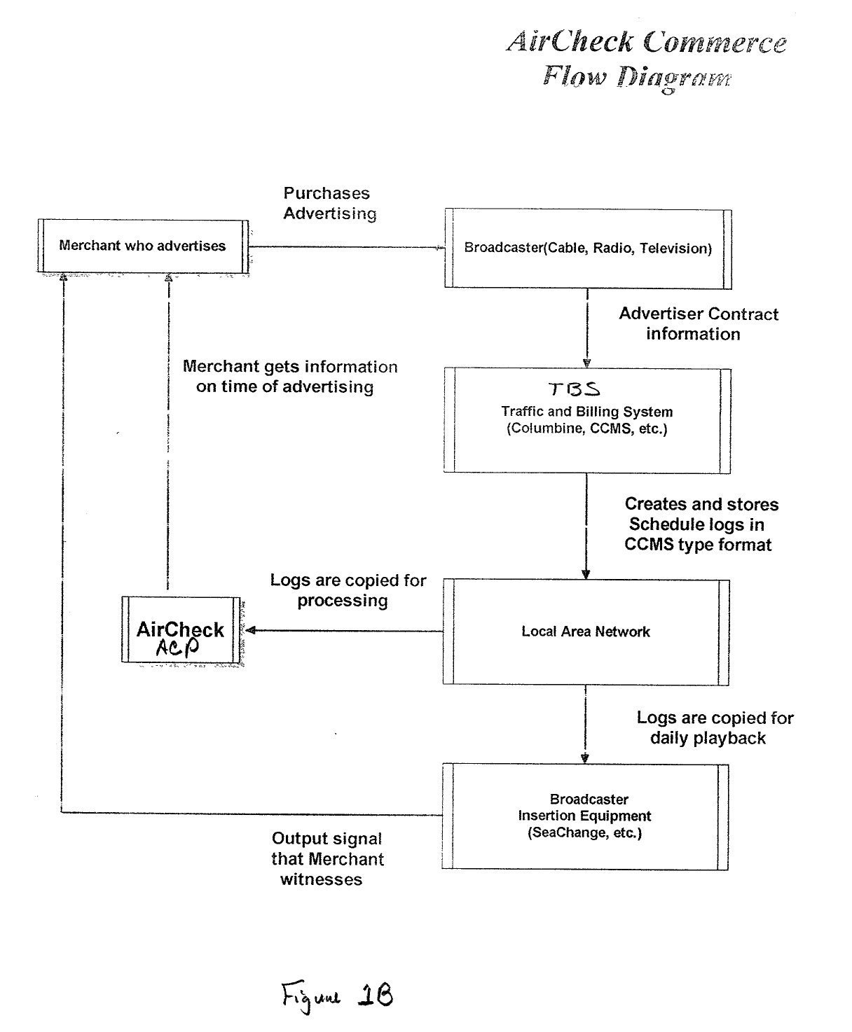

The AirCheck Program can be engaged when the Schedule or Event Logs are completed and available for the next reporting period, such as for the next day. See FIG. 2. FIG. 2 illustrates work flow with an AirCheck Program implemented. A system would be implemented such that the AirCheck Program ACP is engaged after the tracking and billing system has completed the next day's logs such as Schedule Logs SL. The AirCheck Program ACP queries Q whether there is a client that requests scheduled times for the next period, the request not having yet been satisfied. If so the AirCheck Program compiles the appropriate data for the client and faxes the schedule to the client. The schedule at least contains the times at which the client's ad is to be displayed.

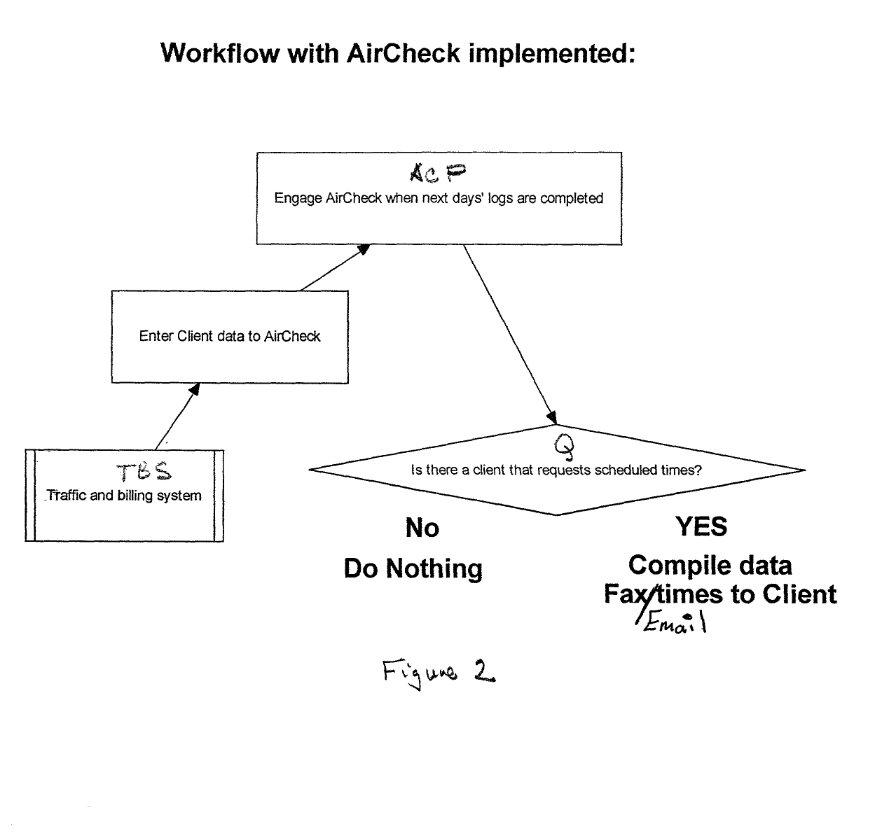

FIG. 3 illustrates by flowchart the operation of a Fax Times Module FTM of a preferred embodiment of the instant invention in more detail. The program retrieves a date range DR for the report and secures from event log files EL (or Schedule Log) a copy of the record covering the day or period DR specified. In the preferred embodiment the Event Log EL is copied to a database where data related to specific fields is parsed to produce ELP. The Fax Times Module FTM program then retrieves a client file CF log and opens a fax software FS. Given a valid client request for the date range, the program searches the event log file ELF for existing times of ads. (Even if no time exists for an ad of a client in the period, a client has the option of receiving a notification.) Data regarding the times found is organized and sent to the fax software FS where an assimilated report is faxed (or e-mailed) to the client. See Table 3.

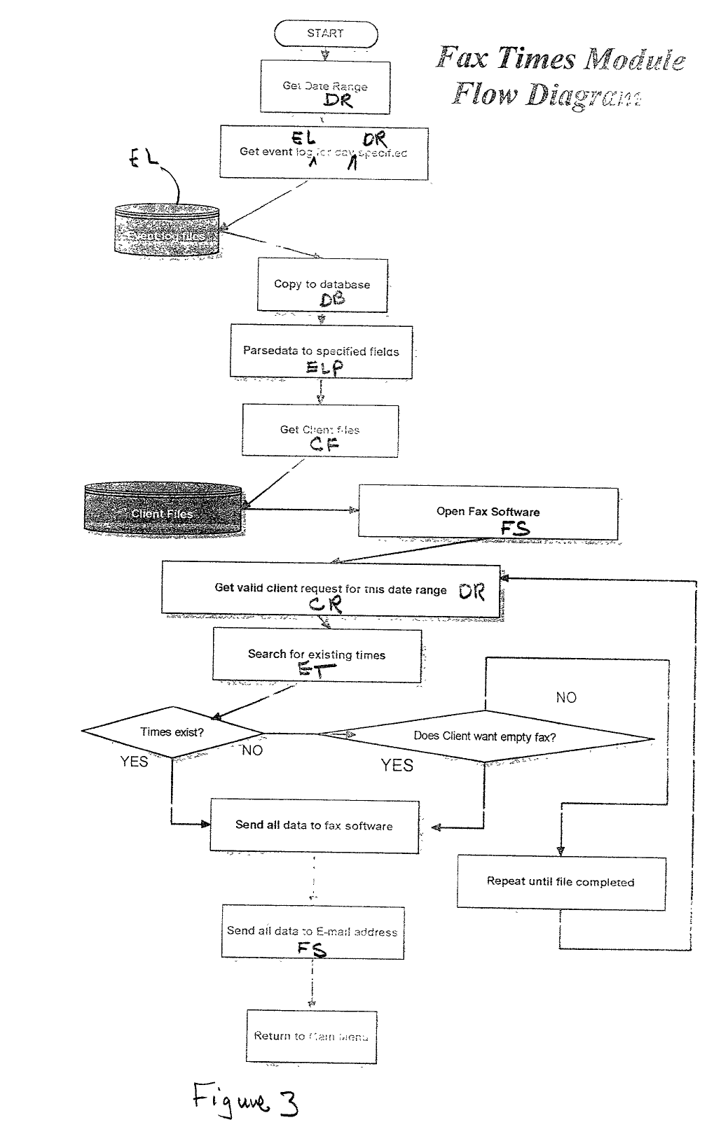

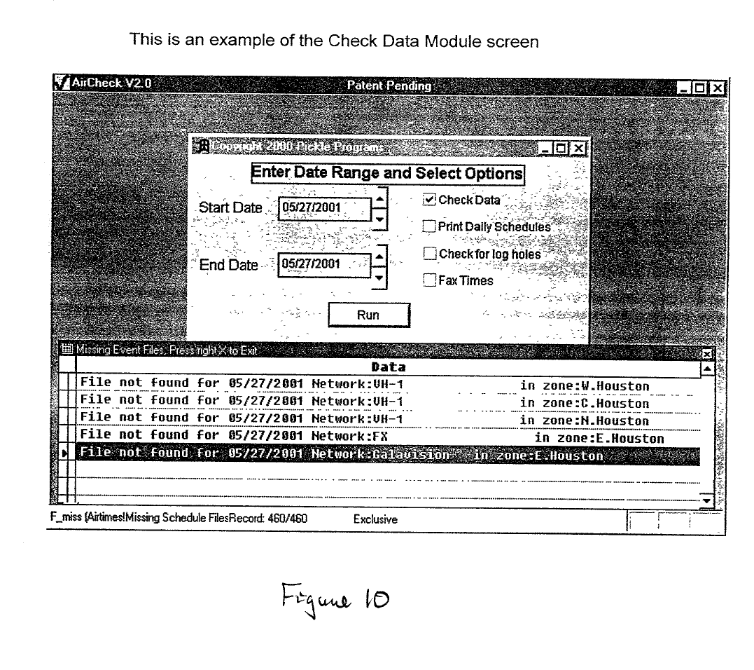

A Check Data Module CDM is offered as an enhancement. See FIG. 4. Past traffic and billing systems periodically failed to create all necessary inserter text files for the next day. Check Data locates which text files are missing for the next day by comparison of existing files with a list of inserters. The missing files, if any, are presented to a screen where an operator can redo the procedure for the missing text file. The Check Data Module refers to an inserter database ID for information in regard to all possible or eligible inserters. An inserter is a station or channel in a given zone. The inserter files ID are compared against the Event Log ELP files to detect the off chance that a given inserter might have been inadvertently omitted by the traffic and billing system TBS in the days Event Logs EL. Any omissions could be printed to a screen for action to be taken. FIG. 10 is an example of the Check Data Module screen.

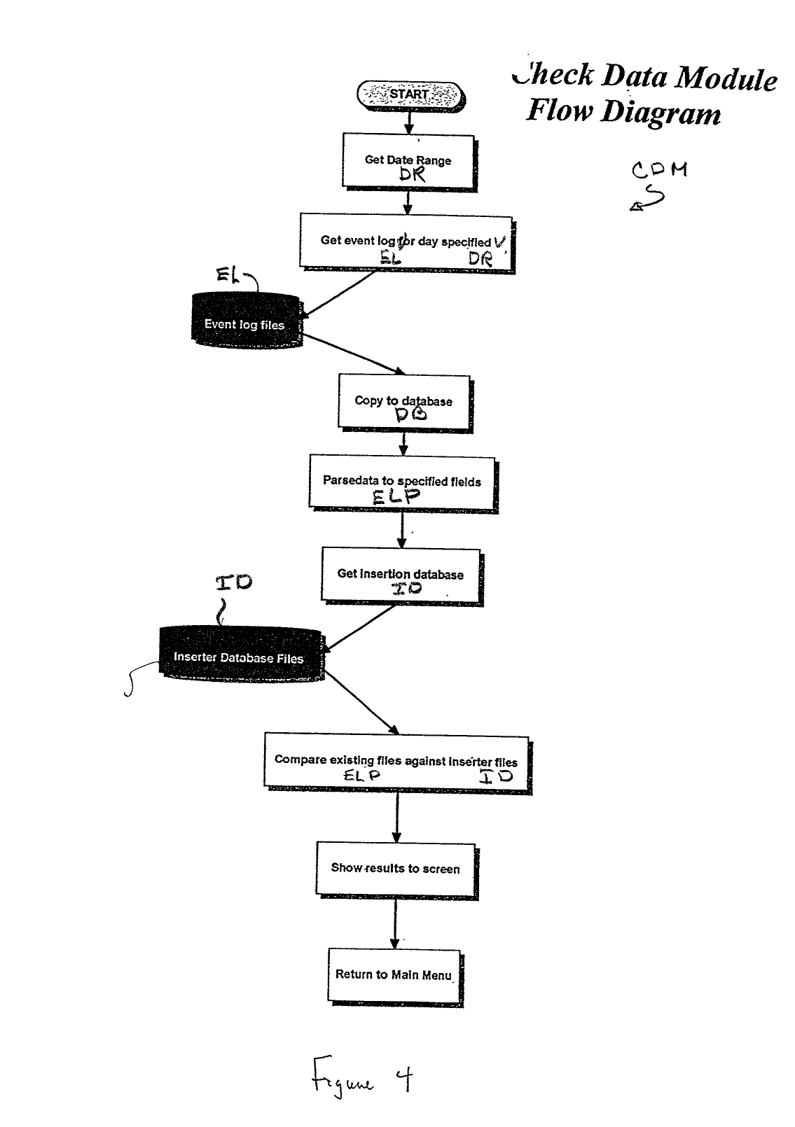

FIG. 5 illustrates a further enhancement of the instant system. A Print Schedule Module PSM prints a schedule of all ads per client for all times for all inserters for a next given report period. Such printed schedule may be distributed to account managers who can check to determine if their advertising clients are receiving the agreed upon advertising of their contract.

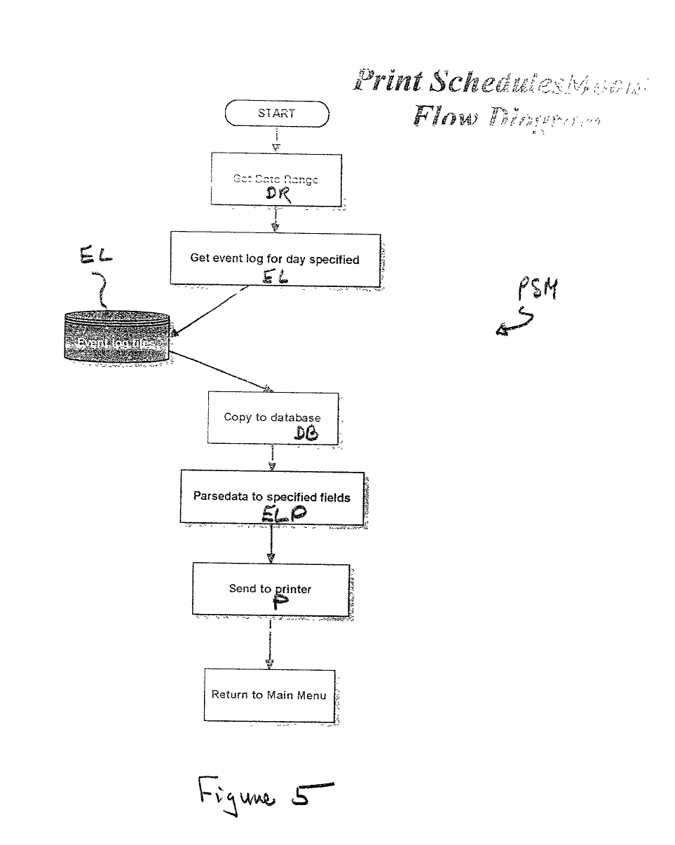

FIG. 6 illustrates that a preferred embodiment AirCheck Program in addition contains the capability to add or edit client information CI and add or edit inserter information II. The client information CI and the inserter information is used in client files CD and inserter files ID in order to generate client reports and to check inserter information against event logs.

The following illustrates a check missing data routine. Table 4 illustrates an example of an inserter file ID. Active networks for San Antonio zone are listed for example. The AirCheck Program has been pre-configured during installation to anticipate which traffic and billing program TBS is being used. The traffic and billing system of San Antonio, for instance, may put all event files for all networks into one large file EL. After a date range DR has been entered by an operator and a check missing data function has been requested, the AirCheck Program starts to compare the inserter file ID with the event log EL.

Since San Antonio has a large file system, the program looks for a drive where the Event Log EL data is located. This may be taken from a location field of the inserter database ID. Thus, the Event Log EL files are located in the P drive, as indicated by Table 4. The EL file may start with EL which may be the first two characters of the file. (See Table 8A) This is followed by the two digit year, two digit month and two digit day. The last characters of the file may be the letter Z plus a two digit zone or area number. (See Table 8A) E.g., in the case of October 17 for zone 1, the program would look and get a file indicated by: “P:\EL001017.Z01”. Once the file is found, the event data is located and parsed to ELP. Table 5 gives an example of the raw parsed data. The left two characters in Table 5 are the inserter numbers. The AirCheck Program compares the inserter number from the inserter data previously entered (Table 4) against the two left characters of the raw data.

Another traffic and billing system may use a separate file for each network in each zone, e.g., for each inserter. The AirCheck Program uses the inserter data previously entered (Table 4) to find these files. In this system the first character would be the month. (See Table 8B) The next two characters are a two digit day of the month, followed by a two digit inserter number. The next three characters are a three digit zone number. The extension can be any three characters determined by the traffic and billing system. In the instant example, the system uses “SCH” meaning a schedule file. The program looks for the proper file and using the same data, October 17, the program searches for files in this traffic and billing system. Using the above example, the program searches for COMEDY CHANNEL in Drive P in zone 1:P:\A1708001.SCH.

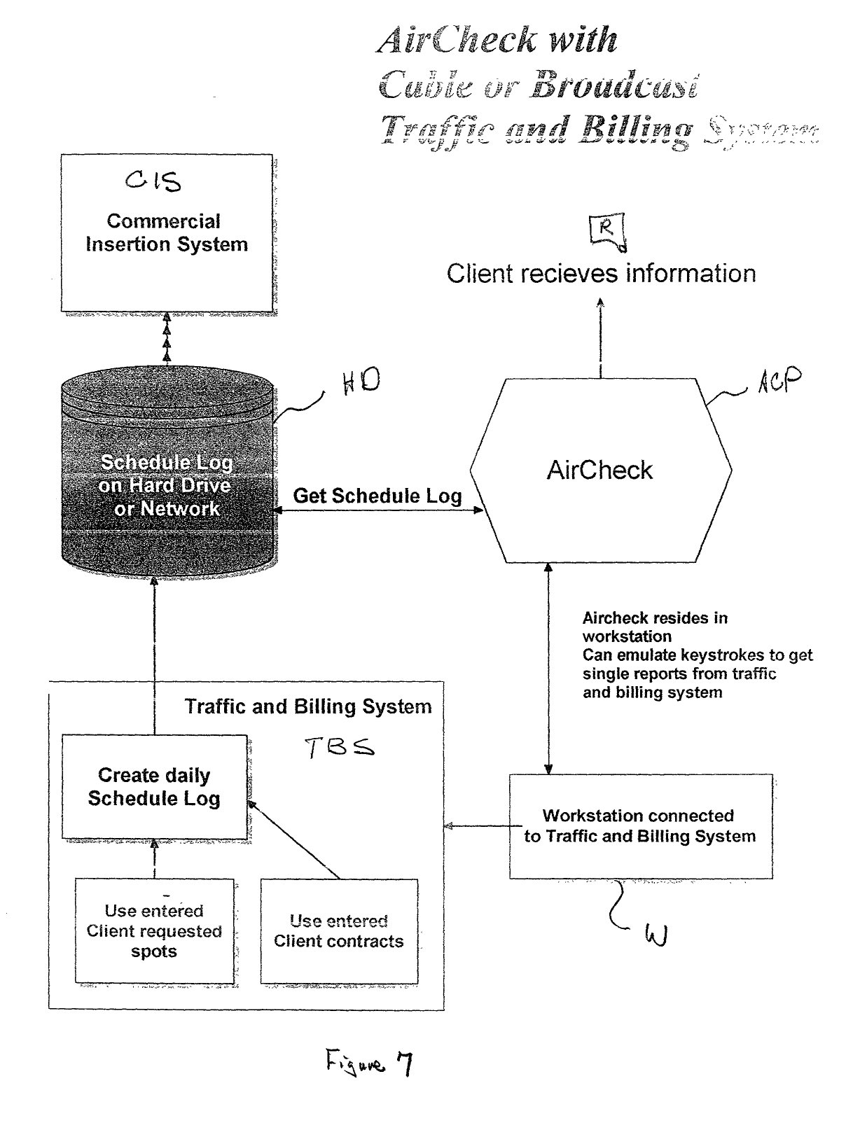

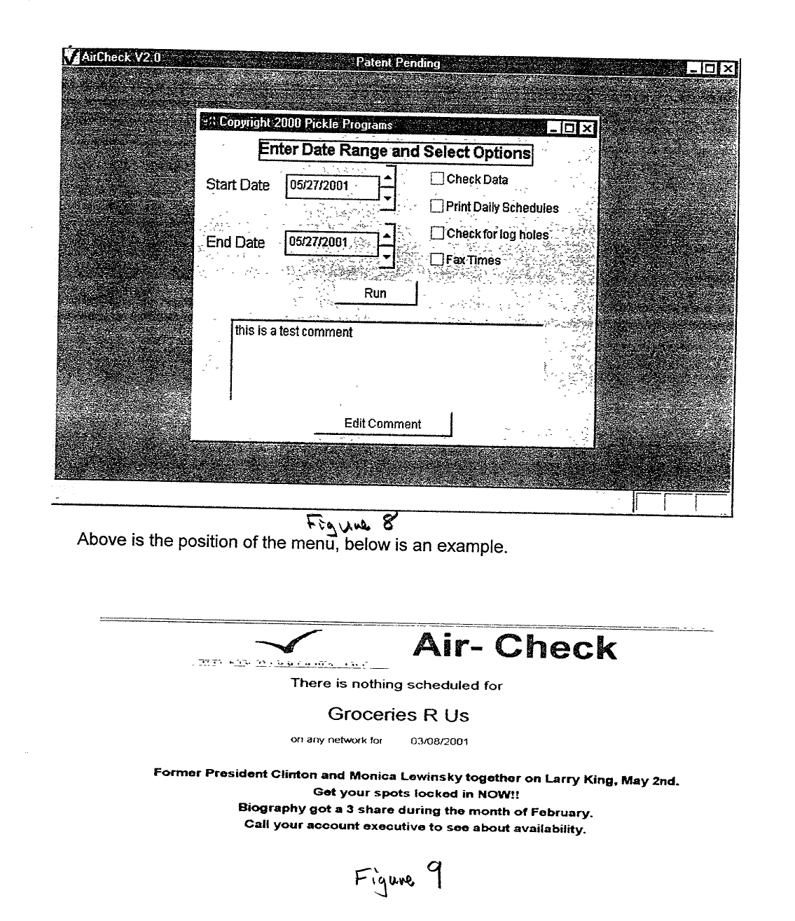

Comment is a further tool of preferred embodiments for communication with all clients that participate in having their schedules transmitted to them. The AirCheck communication company user can add “comments” C to a comment window CW that can be opened in an AirCheck sub-menu before the advertiser client schedules are sent to the client. The comment C is typically a stored text file that is added to the bottom for the fax or E-Mail. FIG. 8 illustrates the position of the menu and an example of a comment in FIG. 9 which could be regarded as an ad or a banner for the communications company.

There are two Internet uses for AirCheck. The first is to send all schedule data indexed by client advertisers to a web server. That web server would allow a client advertiser with the appropriate login and password to view and/or print their own schedule data to a local printer.

The second is for tracking banners on web pages. A means for compiling an Internet Schedule Log likely does exist or will exist. A system for an Internet site analogous to an inserter, and instructed by an Inserter Log or its analogy, likely does or will exist. Such system would insert client add “banners” into banner windows of an Internet site according to client contracts. On the Internet, the timing of the advertising could be controlled by “hits”. That is, a set of banners could be rotated in accordance with hits to the site. In such case the schedule report to a client could report, to the extent pertinent and relevant, the site, the banner or ad copy and the banner rotation note. An Internet “traffic and billing” or similar such system could produce a schedule for the planned locations and times for advertisers' banners. As with other communications companies an AirCheck program or the like could access the schedule and produce a report per advertiser for a coming relevant period, giving locations and timing for banner exhibit, and transmit the report to the client advertiser. The information could be sent to the advertiser by AirCheck via fax and/or e-mail and/or be posted to a website. An enhanced version could track the amount of “hits” (persons who look at the web page) and “click throughs” (persons who click on the banner) from the traffic and billing or similar system and send that historical information to the advertiser through AirCheck via fax and/or email and/or website.

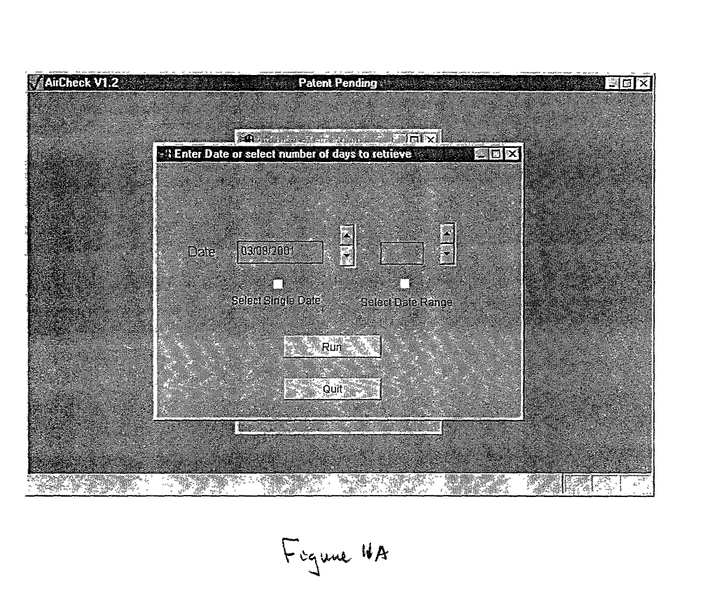

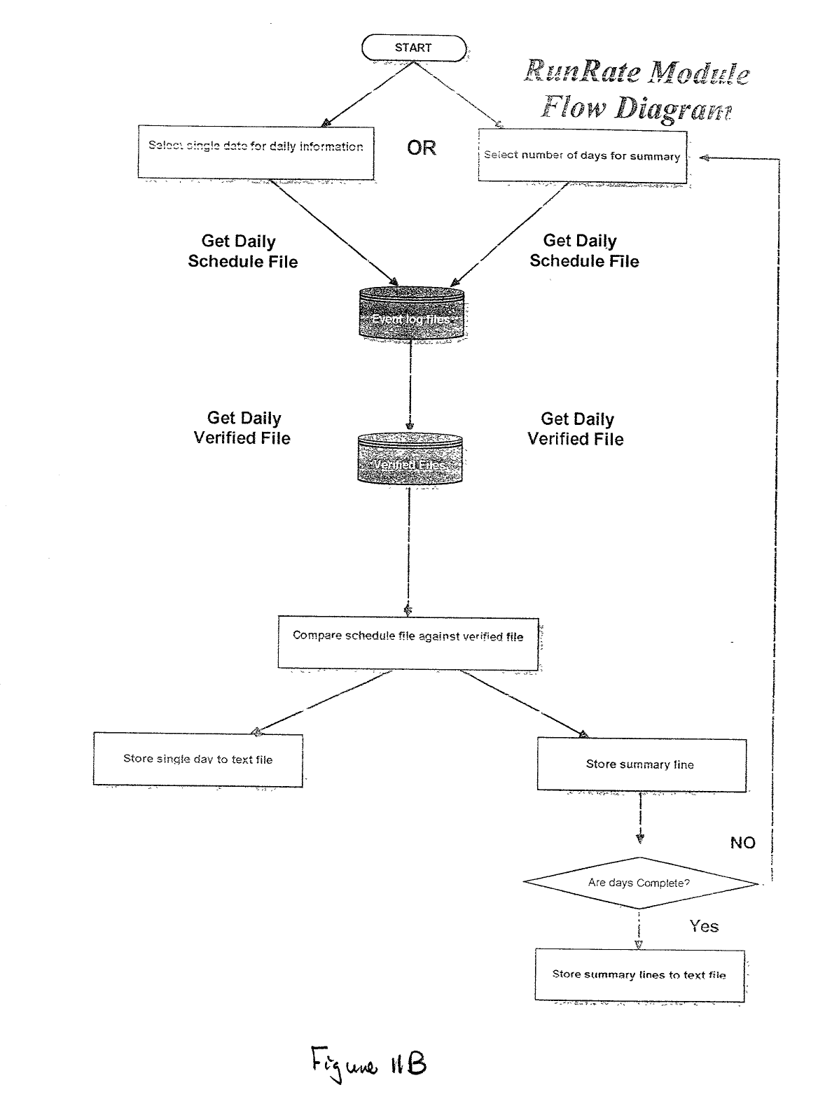

A further option provided by a preferred embodiment is a RunRate module. The user determines if it wants to select a specific day for a daily report or a number of days in the past for a multiple day summary. See FIG. 11A. On a daily report, after the day is selected the program imports all schedule files SL. The program also imports all “as-run” or verified files VF from the commercial inserter. Comparison is made between the schedule file and the verified file. See FIG. 11B.

All scheduled spots are summed. All verified spots are summed. See Table 6. The first line is the total of scheduled spots, total of verified spots and then a percentage of verified spots divided by scheduled spots. The rest of the report shows every spot that failed to air correctly according to time, network and zone.

The multiple day summary gives the percentages for each day requested. See Table 7. Alternately a RunRate report could be by advertising client. In this case details regarding any specific omission could be furnished. Such report could be interesting to, and thus forwarded to, the company, account representatives and/or an advertising client.

### EXAMPLE

The following is an example of how one preferred embodiment of AirCheck works. Presume Joe's Pool Hall wants ten spots a day on CNN through the local Cable Communication Company. All ten spots will air between the hours of 6:00 a.m. and midnight on CNN during the local three minutes of local advertising time each hour. This contract is for the next two weeks. The Cable Company enters the contract data into a traffic and billing system TBS. See FIG. 7.

A traffic and billing system has the advertising contract data entered, produces a daily playlist (an Event Log EL or Schedule Log SL) of all entered advertisers and bills the advertisers for fulfilling the contract by correctly airing spots.

At least one day before, the Event Log (or Schedule Log) for each network is created by the traffic and billing system: E.g.,

CNN—Oct. 26, 2000—Local Cable Company

| Scheduled Time | Client | Spot Number | Length |
|---|---|---|---|
| 12.29 a.m. | Local Cable Promo | 12344 | 30 |
| | Joe's Pool Hall | 12988 | 30 |
| 12:56 a.m. | Friendly Ford Dealer | 21399 | 30 |
| | Casino Center | 12811 | 30 |
| | Local Cable Promo | 12344 | 30 |
| | Public Service Announcement | 22443 | 30 |

(See FIG. 7)

The rest of the day is repeated as above with different advertisers as well as the nine other spots of Joe's Pool Hall. That will fulfill Joe's Pool Hall contract of ten spots a day.

This list is sent (made available electronically) to a commercial insertion system, which is a set of one or more inserters) or a tape compiler (computer program) that will read the list and pull copy for the requested spots from either an active library or archive. The requested spots will be online and waiting for the signal from CNN to play the spots at the designated time.

In the first example, the digital insertion system by 12:15 a.m. on October 26 has retrieved and copied spot number “12344—Local Cable Promo” and spot number “12988—Joe's Pool Hall” from the video library and has both spots ready to play back over the CNN national feed at 12:29 a.m.

The cue tone comes from CNN at 12:27 a.m. Both spots play correctly. (An “As Run” log is created for the date, containing the same information as the Event Log, plus the exact time each spot aired and that the spot aired correctly.) The insertion system gets and copies the four spots that are scheduled at 12:56 a.m. from the video library.

After midnight the next day the insertion system transfers the “As Run” log back to the traffic and billing system. This log has all the data of the Event Log, but also has the exact time each spot aired. The traffic and billing system compiles a bill for all spots that aired correctly and bills the client accordingly.

Using the above example, the following shows how AirCheck comes into the picture. Joe's Pool Hall has bought ten spots on CNN each day for two weeks. Joe has requested to know his scheduled times before they air. (The traffic and billing system might be able to print a report specific to Joe's Pool Hall showing the scheduled times. But according to the prior art, the necessity for a report for Joe's Pool Hall would have to be humanly noted, the report manually requested and faxed (or e-mailed) with manual assistance.)

The advantage of using AirCheck is that with the program initiated for the day (or automatically days), after the Event Log is created, AirCheck (AC) can access automatically the same text file that is made available to the inserter system. AC would fax not only to Joe's Pool Hall, but also to every other client that has requested an exact schedule times for the next day. This is accomplished without manually compiling the schedule form the traffic and billing system if necessary, printing the schedule or manually faxing (or e-mailing) to each client that airs on the cable or broadcast system.

The foregoing disclosure and description of the invention are illustrative and explanatory thereof, and various changes in the size, shape, and materials, as well as in the details of the illustrated system may be made without departing from the spirit of the invention. The invention is claimed using terminology that depends upon a historic presumption that recitation of a single element covers one or more, and recitation of two elements covers two or more, and the like.

[image]

[image]

[image]

[image]

[image]

[image]

[image]

[image]

What is claimed is:

1. An improved method for communicating a future timing of ad broadcasts, comprising:
electronically accessing an electronically stored record indicating, directly or indirectly, at least media, times and titles for broadcast ads for a future designated period;
electronically generating a client report including at least a time for a broadcast of an ad in a future period; and
electronically transmitting the report to a client prior to broadcast.

2. The method of claim 1 including generating the electronically stored record by a traffic and billing system.

3. The method of claim 1 that includes copying at least a part of the electronically stored record onto a separate file.

4. The method of claim 1 that includes identifying at least media, time and title information within records created by different traffic and billing systems.

5. The method of claim 1 wherein transmitting is at least by one of fax and email.

6. The method of claim 1 wherein transmitting includes a banner.

7. The method of claim 1 that includes transmitting report information to an account manager for the client.

8. A system for assessing broadcast advertising, comprising:
electronically accessing a broadcast schedule log;
compiling a schedule report by advertising client; and
electronically transmitting the report to a client prior to broadcast.

9. A system for assessing broadcast advertising, comprising:
electronically accessing a client schedule report complied by a traffic and billing system; and
electronically transmitting the report to a client prior to broadcast.

10. A system for assessing broadcast advertising, comprising:
means for electronically compiling a broadcast Schedule Log;
means, in communication with the Schedule Log means, for electronically compiling a client report by advertising client; and
means, in communication with the client report means, for transmitting the report to a client.

11. A system for assessing broadcast advertising, comprising:
electronically accessing inserter data and a broadcast Schedule Log;
electronically comparing inserter data with Schedule Log data; and
outputting an indicia of inserter omission.

12. A system for assessing broadcast advertising, comprising:
means for electronically accessing inserter data;
means for electronically accessing a broadcast Schedule Log;
means, in communication with the inserter data means and Schedule Log means, for electronically comparing inserter data with schedule log data; and
means, in communication with the comparing means, for outputting an indicia of inserter omissions.

13. A system for assessing broadcast advertising, comprising:
electronically accessing a broadcast Schedule Log and a verified file; and
outputting a measure of the effectiveness of a broadcast media in executing advertising in accordance with the Schedule Log.

14. The system of claim 13 that includes outputting a measure of effectiveness by advertising client.

15. The system of claim 14 that includes outputting an indicia of an omitted ad.

16. A system for assessing broadcast advertising, comprising:
means for electronically accessing a broadcast Schedule Log;
means for electronically accessing a verified file;
means, in communication with the Schedule Log means and verified file means, for outputting a measure of the effectiveness of a broadcast media in executing advertising in accordance with the Schedule Log.
